(19) United States
(12) Patent Application Publication
(10) Pub. No.: US 2024/0047716 A1
(43) Pub. Date: Feb. 8, 2024

(54) BATTERY STORAGE POWER PLANT WITH A COOLING SYSTEM

(71) Applicant: Voith Patent GmbH, Heidenheim (DE)

(72) Inventors: Thomas Lüth, Freiburg (DE); Lorenz Lenhart, Ulm (DE)

(73) Assignee: Voith Patent GmbH, Heidenheim (DE)

(21) Appl. No.: 18/490,945

(22) Filed: Oct. 20, 2023

Related U.S. Application Data
(63) Continuation of application No. PCT/EP2022/055968, filed on Mar. 9, 2022.

(30) Foreign Application Priority Data
Apr. 22, 2021 (DE) 10 2021 110 200.6

(51) Int. Cl. H01M 8/04276; H01M 8/04029; H01M 8/18

(52) U.S. Cl. CPC H01M 8/04276; H01M 8/04029; H01M 8/188

(57) ABSTRACT

A battery power plant includes: battery modules of the Redox Flow type, battery strings, and a cooling system, wherein all battery modules are connected to the flow and return of the cooling circuit such that the cooling circuit forms a parallel connection of all the battery modules, the cooling system including at least one three-way valve for controlling a volume flow of the cooling fluid flowing through the cooling device, the cooling system for each of the battery modules including at least one first valve for controlling a volume flow of the cooling fluid flowing through the heat exchanger of an associated battery module, and the cooling system including a control device for processing values measured by the first temperature sensor and the second temperature sensor and for controlling settings of the first valve and the three-way valve in order to improve the efficiency of the battery power plant.

### CROSS REFERENCE TO RELATED APPLICATIONS

This is a continuation of PCT application no. PCT/EP2022/055968, entitled “BATTERY STORAGE POWER PLANT HAVING A COOLING SYSTEM”, filed Mar. 9, 2022, which is incorporated herein by reference. PCT application no. PCT/EP2022/055968 claims priority to German patent application no. 10 2021 110 200.6, filed Apr. 22, 2021, which is incorporated herein by reference.

### BACKGROUND OF THE INVENTION

### 1. Field of the Invention

The present invention relates to batteries, and, more particularly, to battery power plants.

### 2. Description of the Related Art

Battery power plants of this type with a plurality of separate battery energy storage devices, which are also referred to as battery modules, are known from the current state of the art. WO 2014/170373 A2 discloses a battery power plant having several in-series connected battery strings, wherein the battery strings respectively include several direct current battery modules which are connected in series.

Moreover, it is known from the state of the art that individual Redox Flow battery modules can be provided with a cooling device. To this end, a battery module of this type includes one or several heat exchangers with which the electrolyte of the battery module can be cooled. The heat exchangers can thereby be arranged at various locations of the battery module, for example in or on the electrolyte tanks or respectively on one of the tanks, in the cells of the battery module or on the pipe system by with which the electrolyte is circulated. In this regard, reference is made to documents WO 2019/126381 A1, U.S. Pat. No. 9,774,044 B2 and WO 2019/139566 A1.

What is needed in the art is a Redox Flow type battery power plant with battery energy storage devices which is suitable for improving the efficiency of the battery power plant.

### SUMMARY OF THE INVENTION

The invention relates to a battery power plant with a cooling system, wherein the battery power plant includes a plurality of separate battery energy storage devices which are electrically connected with each other to receive or deliver electrical energy. The invention relates to a battery power plant with battery energy storage devices, which are designed as Redox Flow batteries.

The present invention in one form is directed to a battery power plant which includes a plurality of battery modules of the Redox Flow type, wherein battery modules are arranged in several battery strings connected in parallel, and wherein a battery string each includes several battery modules which are connected in series, and wherein each battery module includes a tank device for storing electrolyte, at least one temperature sensor and at least one heat exchanger, wherein the temperature sensor is arranged in such a way that it can detect an electrolyte temperature, and wherein the heat exchanger is arranged and designed in such a way that it can exchange heat with an electrolyte, and wherein the battery power plant includes a cooling system for supplying a cooling fluid to the heat exchangers of the battery modules, and wherein the cooling system includes a cooling circuit with a supply and a return, at least one cooling device and at least one circulating pump for circulating the cooling fluid in the cooling circuit, and wherein the cooling device is designed in such a way that it can influence a temperature difference between the flow and the return, and the cooling system including at least two other temperature sensors for detecting the temperature of the flow and return, characterized in that, all the battery modules are connected to the flow and return of the cooling circuit in such a way that the cooling circuit forms a parallel connection of all the battery modules, and wherein the cooling system includes at least one three-way valve, which is arranged in such a way that it can control a volume flow of the cooling fluid flowing through cooling device, and wherein the cooling system for each battery module includes at least one valve, which is arranged in such a way that it can control a volume flow of the cooling fluid flowing through the heat exchanger of an associated battery module, and wherein the cooling system includes a control device which is designed to process the values measured by the temperature sensors and to control the settings of the valves and the three-way valve, to improve the efficiency of the battery power plant.

Further, several of the battery modules form a cooling string, wherein the cooling string includes two parallel lines, and each battery module belonging to the cooling string is connected to the two lines in such a way that they form a parallel connection, and wherein a three-way valve (8) is provided for the cooling string, which is arranged in such a way that it can control a volume flow of the cooling fluid, which flows through the respective cooling string, and wherein control device is designed in such a way that it can control the setting of the three-way valve belonging to the cooling string.

The present invention in another one form is directed to a method for the operation of a battery power plant, wherein the battery power plant includes a plurality of battery modules of the Redox Flow type, and wherein the battery modules are arranged in several battery strings connected in parallel, and wherein a respective battery string respectively includes several battery modules which are connected in series, and wherein each battery module includes a tank device for storing electrolyte, and at least one temperature sensor and at least one heat exchanger, wherein the temperature sensor is arranged in such a way that it can detect an electrolyte temperature, and wherein the heat exchanger is arranged and designed in such a way that it can exchange heat with an electrolyte, and wherein the battery power plant is equipped with a cooling system to supply the heat exchanger of battery modules with a cooling fluid, and wherein the cooling system includes a cooling circuit with a supply and a return, at least one cooling device and at least one circulation pump for circulating the cooling fluid in the cooling circuit, and wherein the cooling device is designed in such a way that it can influence a temperature difference between the flow and the return, and wherein the cooling system includes at least two additional temperature sensors for detecting the temperature of the flow and return, and wherein all battery modules are connected to the flow and return of the cooling circuit in such a way that the cooling circuit forms a parallel connection of all battery modules, and wherein the cooling system includes at least one three-way valve which is arranged in such a way that it can control a volume flow of the cooling fluid, flowing through the cooling device, and wherein the cooling system for each battery module includes at least one valve, which is arranged in such a way that it can control a volume flow of the cooling fluid flowing through the heat exchanger of an associated battery module, and wherein the cooling system includes a control device which is designed in such a way that it is able to process the values measured by the temperature sensors and to control the settings of the valves and the three-way valve, and wherein the method includes at least one operating state in which the valves and the three-way valve are/is controlled in such a way that at least one battery module absorbs heat through the cooling fluid circulating in the cooling circuit which has been transferred to the cooling fluid by another battery module.

Further, several battery modules form a cooling string, wherein the cooling string includes two parallel lines, and wherein each battery module belonging to the cooling string is connected to the two lines in such a way that they form a parallel connection, and wherein a three-way valve is provided for the cooling string, which is arranged in such a way that it can control a volume flow of the cooling fluid flowing through the respective cooling string, and wherein the control device is designed in such a way that it can control the setting of the three-way valve associated with the cooling string.

Further, the battery power plant is operated in at least one operating state at partial load, and wherein at least one battery module, which absorbs heat through the cooling fluid circulating in the cooling circuit, is in stand-by mode.

Further, wherein the battery power plant is operated in at least one operating state at partial load, and wherein at least one battery module, which absorbs heat through the cooling fluid circulating in the cooling circuit, is charged.

The present invention in yet another one form is directed to the battery power plant described above, which is arranged to carry out the method (described above) automatically.

The present invention in yet another one form is directed to a computer program including instructions which cause the battery power plant to carry out the method.

The present invention in yet another one form is directed to a computer-readable medium on which the computer program is stored.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawing, wherein:

FIG. 1 is a battery module of the Redox Flow type;

FIG. 2 is a battery power plant according to the present invention; and

FIG. 3 is an electric structure of a battery power plant.

Corresponding reference characters indicate corresponding parts throughout the several views. The exemplifications set out herein illustrate at least one embodiment of the invention, and such exemplifications are not to be construed as limiting the scope of the invention in any manner.

### DETAILED DESCRIPTION OF THE INVENTION

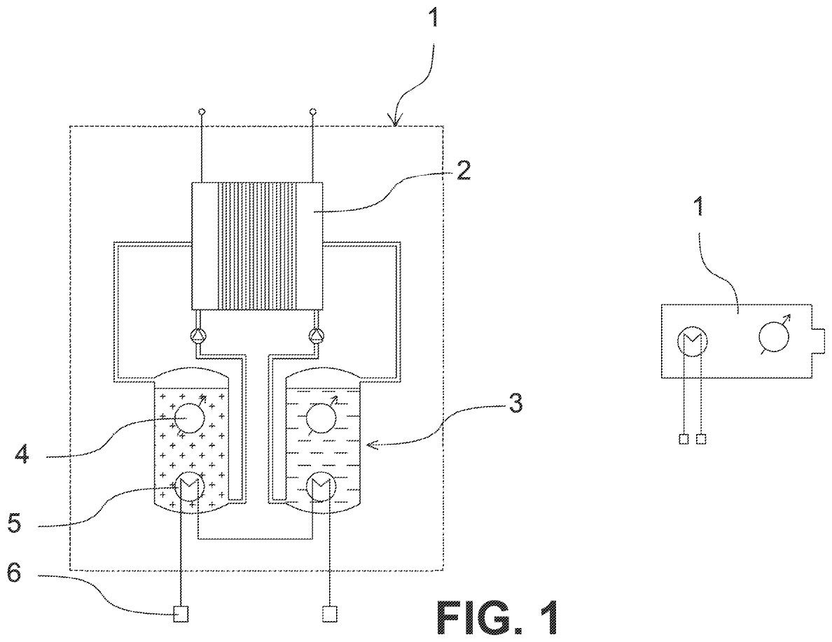

On the left side of FIG. 1 is a schematic illustration of a battery module, of the Redox Flow type. The battery module carries identification number 1. The battery module includes a cell arrangement 2, and a tank device 3. Cell arrangement 2 is an arrangement consisting of a multitude of Redox Flow cells, which can be randomly arranged. For example, it could be a single cell stack (in other words, a series connection of multiple Redox Flow cells), a series connection of multiple stacks, a parallel connection of multiple stacks, or a combination of series and parallel connection of multiple stacks. Tank device 3 serves to store the electrolyte and to supply cell arrangement 2 with electrolyte. For this purpose, tank device 3 includes—with a few exceptions—at least two tanks, a pipe system for connecting the tanks to cell arrangement 2, and pumps for delivering the electrolyte. FIG. 1 shows two separate pumps. The electrolyte could also be delivered by a double-head pump, in other words, by two pumps which are driven by a common motor. Tank device 3 is designed in such a way that it can supply all cells of cell arrangement 2 with electrolyte. If the pumps deliver the electrolyte, the latter flows through all cells of cell arrangement 2.

Battery module 1 includes at least one temperature sensor which is arranged so that it can detect an electrolyte temperature. Two such sensors are illustrated in FIG. 1; one of which is identified with 4. In the embodiment according to FIG. 1 temperature sensors 4 are located in tank device 3. They could, however, just as easily be arranged on any other suitable location in battery module 1 where they can capture an electrolyte temperature.

Battery module 1 moreover includes at least one heat exchanger which is arranged and designed in such a way that it can exchange heat with an electrolyte of battery module 1, meaning, that it can draw heat from an electrolyte or can supply heat to an electrolyte. Two such heat exchangers are illustrated in FIG. 1, one of which is identified with 5. In the embodiment according to FIG. 1, heat exchangers 5 are arranged in tank device 3. They could, however, just as easily be arranged at any other suitable location in battery module 1 where they could facilitate a heat exchange with electrolyte. In order for a heat exchanger 5 to fulfill its function, it must have a cooling fluid flowing through it, which is supplied to heat exchanger 5 from outside of battery module 1. Suitable supply lines must be provided for this purpose. In FIG. 1, the supply lines are designed in such a way that the two heat exchangers 5 shown are connected in series; in other words, the cooling fluid flows first through one heat exchanger 5 and then through the other. Heat exchangers 5 could just as easily be connected in parallel or supplied with cooling fluid separately from one another.

In Redox Flow battery modules based on vanadium, the two electrolytes (positive and negative electrolyte) show different thermal behavior. Therefore, in a series connection of the heat exchangers, the flow direction of the cooling fluid would be chosen in such a way that the cooling fluid first flows through the heat exchanger, which is in contact with the positive electrolyte, and only then flows through the heat exchanger, which is in contact with the negative electrolyte.

At least one valve with which the flow of cooling fluid through relevant heat exchanger 5 can be controlled is arranged in the supply lines for supplying heat exchangers 5 with cooling fluid. FIG. 1 shows two such valves, one of which is identified with 6. To ensure the functionality of the embodiment shown in FIG. 1, one of the two valves 6 would suffice. If two valves 6 are provided, this facilitates the installation or replacement of battery module 1 in a battery power plant according to the present invention, since the battery module in question can be completely decoupled from the cooling circuit. FIG. 1 shows valves 6 outside of battery module 1. They could, however, also be part of battery module 1, in other words, they could be arranged within the dashed frame.

On the right side of FIG. 1, a symbolic representation of battery module 1 is shown. The illustrated interior of battery module 1 is reduced to at least one temperature sensor 4 and at least one heat exchanger 5.

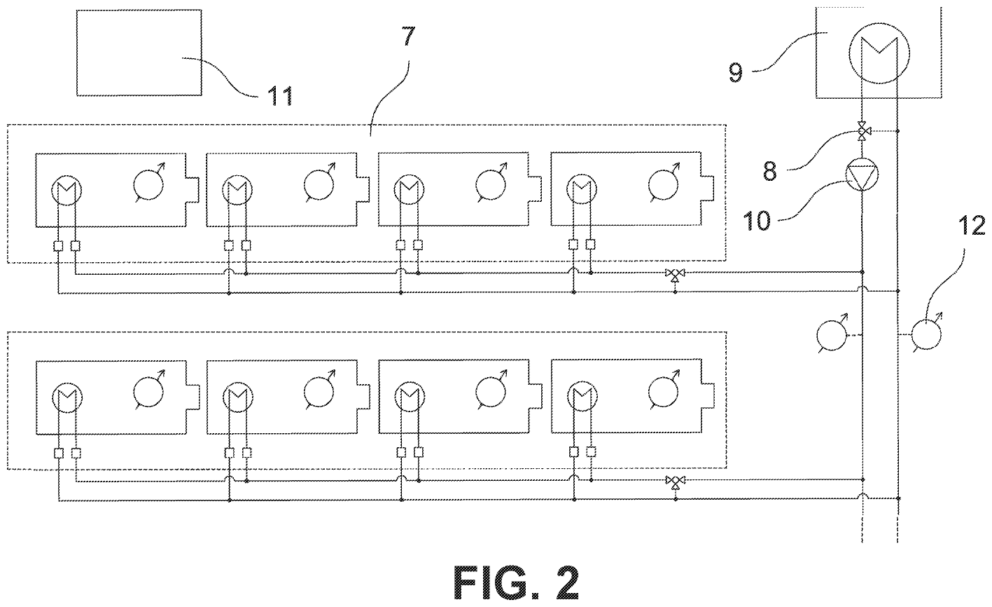

FIG. 2 shows a battery power plant according to the present invention. The battery power plant includes a multitude of separate battery modules 1, wherein battery modules 1 are arranged in several battery strings connected in parallel, and wherein a battery string respectively includes several battery modules 1, which are connected in series. FIG. 2 shows two such battery strings, each marked by a dashed frame. One of the battery strings shown herein is marked 7.

The battery power plant according to the present invention includes a cooling system for supplying heat exchangers 5 of battery modules 1 with cooling fluid. The cooling system includes a supply and a return. All battery modules 1 of the battery power plant are connected with the supply and return; in other words, the cooling circuit of the cooling system forms a parallel connection of all battery modules 1 of the battery power plant. For each battery module 1, at least one valve 6 is provided, with which the cooling fluid flow through heat exchanger(s) 5 of the relevant battery module 1 can be controlled.

To keep the total pipe length of the cooling system as short as possible, it is advantageous to design the cooling system in such a way that the heat exchangers of a number of battery modules form a so-called cooling string. A cooling string includes two parallel lines, wherein each battery module 1 belonging to the cooling string is connected with the two lines. It is proposed, for example, that all battery modules that belong to a battery string form a cooling string. In contrast to the electrical interconnection of the battery modules in a battery string, associated heat exchangers 5 of the battery modules are connected in a cooling string in such a way that they form a parallel connection. A cooling string can also connect the battery modules of more than one battery string. FIG. 2 shows two battery strings as an example, wherein the battery modules of each battery string are connected via an associated cooling string. The two parallel lines of the cooling string respectively flow into a cooling string, which is arranged on the right in FIG. 2 and which hereinafter is referred to as the main cooling string. The cooling strings and the main cooling string form a cooling circuit.

The cooling system moreover includes at least one recirculating pump with which the cooling fluid can be recirculated in the cooling circuit. If the cooling system includes only one recirculating pump this should be expediently located in the main cooling string. In FIG. 2 the illustrated recirculating pump is identified with 10. The cooling system includes a supply and a return, wherein the heat exchangers of the individual battery modules respectively are connected with the supply and a return, as illustrated in FIG. 2.

The cooling system moreover includes at least one cooling device which is identified with 9 and which is connected with the supply and a return. Such a cooling device 9 may include, for example, a heat exchanger and a ventilator, wherein the heat exchanger is designed as a liquid/gas heat exchanger. The ventilator allows cool outside air to flow past the heat exchanger so that the cooling fluid flowing through the heat exchanger is cooled.

The cooling system includes at least one three-way valve. In FIG. 2, a total of 3 three-way valves are illustrated, one of which is identified with 8. One of the three-way valves is therein arranged in such a way that it can control the volume flow of the cooling fluid flowing through cooling device 9. With this three-way valve 8, the temperature difference between the supply and return in the main cooling string and thus the cooling capacity of the cooling system can be influenced. If the volume flow flowing through cooling device 9 is increased, then the temperature difference between the supply and the return in the main cooling string increases. If more than one cooling device 9 is provided, then an associated three-way valve 8 is to be provided for each of the cooling devices 9 provided. Optionally, a three-way valve 8 can also be provided for each cooling string, which is arranged in such a way that it can control the volume flow of the cooling fluid flowing through the respective cooling string, in other words which flows through the two parallel lines of the cooling string. With these additional three-way valves 8, the temperature difference between the supply and return of the respective cooling string can be influenced. In FIG. 2 such a three-way valve 8 is arranged in each illustrated cooling string. If necessary, an additional pump can be arranged in each of the cooling strings, so that sufficient circulation of the cooling fluid in the respective cooling string is still guaranteed at each setting of the associated three-way valve.

In addition to temperature sensors 4 in individual battery modules 1 the cooling system includes additional temperature sensors outside of battery modules 1. A summary representation is shown in FIG. 2 by way of the two sensor symbols, one of which is labeled 12. These are at least sensors 12 for detecting the temperature in the supply and return in the cooling circuit. Additional sensors 12 can optionally also detect the temperature in the supply and return of the individual cooling strings. Temperature sensors 12 can moreover be optionally arranged at different locations in the battery power plant in order to detect the temperature at these locations.

The cooling system moreover includes a control device, which is identified with 11 in FIG. 2. Control device 11 processes the measured values acquired by sensors 4 and 12. Control device 11 controls the positions of valves 6 and 8 in such a way that the efficiency of the battery power plant can be improved. The referred to efficiency may be, for example, energy efficiency relative to the waste heat of the cooling system. However, it can also be the electrical efficiency of the battery power plant, as will become clear from the explanations below.

The control device can also advantageously include additional factors in the described scope of control. Such additional factors are, for example, the weather or a weather forecast, or the historical and forecast load profile of the battery power plant.

The control device obviously also incorporates the thermal behavior of the battery modules into the control management. In general, a battery module of the Redox Flow type becomes electrically more efficient when it gets warmer, as this reduces the internal electrical resistance. However, the temperature of a battery module must not become too high, as destruction processes begin when a critical temperature is exceeded, which must be avoided in any circumstances. This means that the control via the control device must generally be designed in such a way that the battery modules are kept as warm as possible without destroying them thermally.

In Redox Flow type battery modules based on vanadium, charging occurs in an endothermic reaction and discharging occurs in an exothermic reaction. This means that without an external heat supply or heat dissipation, such a battery cools down during charging and heats up when discharging.

Control device 11 may be centrally designed. However, control device 11 may also include sub-control units, arranged in a decentralized manner. For example, each battery module 1 may include a sub-control unit which processes the measured values acquired by temperature sensors 4 which are located in the respective battery module and which controls valves 6 associated with the relevant battery module. In doing so, the sub-control units act at least partially autonomously. The connection between any sub-control units, sensors 4 and 12 and valves 6 and 8 with the control unit 11 can also be wireless.

The inventors have recognized that the battery power plant according to the present invention can improve the energy efficiency of the power plant compared to a conventional battery power plant. The improvement in energy efficiency is thereby achieved by reducing the waste heat from the battery power plant. The inventors have recognized that when operating a battery power plant with battery modules of the Redox Flow type, situations occur repeatedly in which one or more battery modules do not need to be cooled or even need to be heated in order to reach the optimal operating range as quickly as possible, in other words, to reduce internal resistance and increase electrical efficiency.

Thus, battery modules that are in a state of operational pause (stand-by) or are being charged do not require cooling, as they cool down by themselves under these conditions. Battery modules that are newly integrated into the power plant or which have been serviced also require heat to reach the optimum operating temperature. On the other hand, battery modules which are being discharged produce heat and must therefore be cooled. With a battery power plant according to the present invention, this finding can be used to reduce the waste heat of the battery power plant. The operating method of a battery power plant according to the present invention includes at least one operating state in which valves 6 and three-way valve 8 are controlled in such a way that at least one battery module absorbs heat through the cooling fluid circulating in the cooling circuit, which has been transferred to the cooling fluid by another battery module. In other words, the battery modules that absorb heat act as coolers for the battery modules which give off heat.

This can be achieved in several ways. For the sake of simplicity, it is assumed that a first battery module B1 does not require cooling, and that the electrolyte temperature in B1 is T1. It is moreover assumed that a second battery module B2 requires cooling and that the electrolyte temperature in B2 will be T2. Then it would be T1<T2. To achieve the desired heat flow from B2 to B1, the three-way valve associated with the cooling device can be controlled in such a way that flow temperature TV is adjusted to be T1<TV<T2. If the cooling device is now (temporarily) switched out of the cooling circuit, the desired heat flow from B2 to B1 occurs inevitably. Another possibility exists in that for some time only B2 is connected to the cooling circuit while B1 is disconnected from it—then B2 emits heat to the cooling fluid, and subsequently only B1 is connected to the cooling circuit for some time, while B2 is disconnected from it—then B1 absorbs heat from the cooling fluid. Valves 6 associated with the battery modules are used for switching into the cooling circuit and switching out of the cooling circuit. In the second option the cooling device is also switched out of the cooling circuit for the time of the desired heat flow (by way of associated three-way valve 8).

The general arrangement with multiple battery modules that do not require cooling and with multiple battery modules that do need to be cooled can be described in such a way that three-way valve 8 of the cooling device is controlled so that flow temperature TV is close to the average electrolyte temperature of the battery modules. In addition, valves 6 of the battery modules are controlled so that the associated battery modules are periodically switched in or out of the cooling circuit, whereby the length of the alternation depends on the cooling requirement or heat requirement of the respective modules.

Optional three-way valves 8 for individual cooling strings allow further degrees of freedom for the operation of a battery power plant according to the present invention since they can be used to individually adjust the flow temperatures of the individual cooling strings. In addition, they can be used to switch the individual cooling strings completely into or out of the cooling circuit. This is advantageous if one or more cooling strings in their entirety have different cooling requirements than other cooling strings. This can be the case, for example, if the battery modules of one or more cooling strings are arranged at points in the power plant where a different ambient temperature is present. This is the case, for example, when battery modules are stacked on top of each other in the power plant. The battery modules located at the top are exposed to a higher air temperature because the upper air layers heat up due to the waste heat from the battery modules located below. It is then advantageous for the battery modules of the different vertical levels to be combined into cooling strings. With the help of the three-way valves associated with the cooling strings, the flow temperature in the cooling strings can be adjusted so that the flow temperature for cooling strings located higher up is lower than the flow temperature of the cooling strings which are arranged at a lower location.

The inventors have recognized that further advantageous operating modes can be cited for a battery power plant according to the present invention, considering that such a battery power plant often has to operate in partial load operation. Partial load operation can be implemented in several ways. For almost all possible modes of implementation, operating modes can be specified in which the efficiency of such a battery power plant can be increased according to the present invention. To describe these operating modes, the electrical structure of such a battery power plant is explained in further detail below.

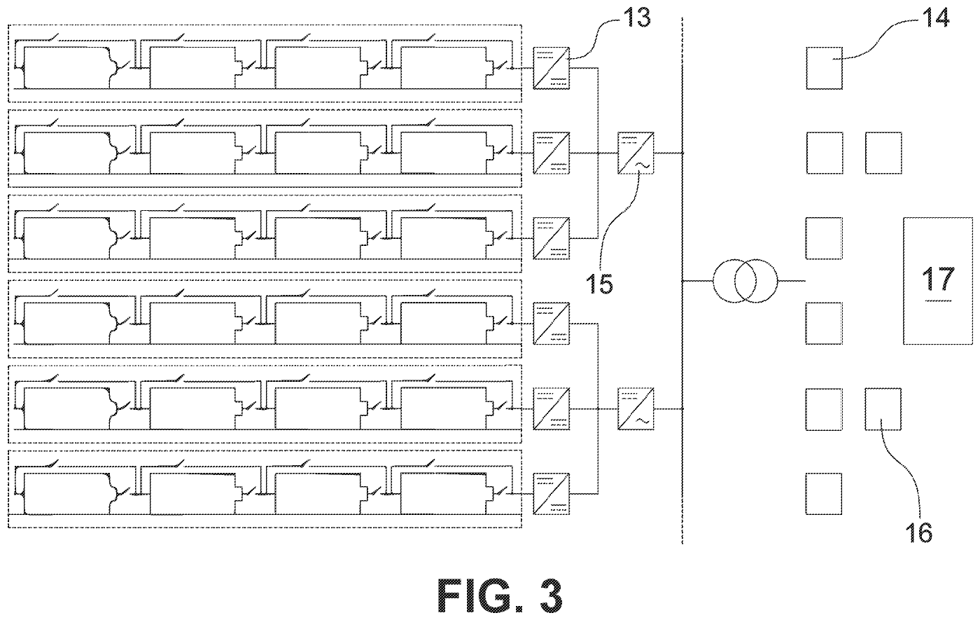

FIG. 3 shows the electrical structure of a battery power plant in a highly simplified representation. On the left side, the battery strings are indicated with a series connection of battery modules. Each battery string is surrounded by a dashed rectangle. Each battery module can be switched in or out of the battery string with the help of a pair of switches. Each battery string is connected to a DC-DC regulator. One of the DC-DC regulators is identified with 13. Several battery strings respectively are connected to each other via a DC busbar and thus each form a battery string group. The DC-DC actuators are arranged between the associated DC busbar and the battery strings. Each battery string group is connected to the AC busbar of the battery power plant via a DC-AC converter. One of the DC-AC converters is identified with 15.

In FIG. 3, three battery strings respectively form a battery string group. However, the number of battery strings per battery string group can be arbitrary and depends only on the capacity of the DC-AC converters used and the nominal capacity of the battery strings. The AC busbar is connected via a transformer to a transmission network.

The right side of FIG. 3 shows the control structure associated with the battery power plant. Each battery string has its own controller, one of which is identified with 14. Each battery string group, in turn, has its own controller, one of which is identified with 16. The central control system associated with the battery power plant is identified with 17. Subordinate controllers 14 and 16 may be designed separately or may be integrated into the control device associated with the central control system. The same applies to device 11 associated with the cooling system.

For realization of a partial load operation of the battery power plant, various possibilities are available:
A: All battery modules are operated at partial load;
B: In a number of battery strings, one or more battery modules are switched out of the respective battery strings and go into stand-by mode;
C: One or more battery strings are operated at partial load or go into stand-by mode;
D: One or more battery string groups are operated at partial load or go into stand-by mode.

Partial load operating mode A offers the advantage that the battery power plant can maintain a homogeneous state, since all battery modules are operated uniformly, thus avoiding to the extent possible an uneven charge level of the battery modules. In regard to increasing the efficiency of the battery power plant, however, there are no or only a few possibilities with this operating mode, precisely because of this homogeneity.

With partial load operating modes B-D, an uneven state of charge of the battery modules results, at least temporarily, since at least some battery modules are charged or discharged not as quickly or not at all compared to the other battery modules. However, by periodically changing the affected battery modules, the resulting imbalance can be kept low or even avoided in the long term. On the other hand, there are some advantages with part-load operating modes B-D in regard to an increase in the efficiency of the battery power plant. In operating modes C and D, the associated DC-DC controllers or DC-AC converters can of course also go into stand-by thereby saving energy. Moreover, as described above, the battery modules, which are in standby, can absorb heat and thus serve as coolers for the remaining battery modules. This is advantageous if the partial load operating mode in question is a discharge process, since heat is produced during discharge, therefore requiring cooling. It is clear that in these modes of operation, control device 11 of the cooling system uses the information about the respective current electrical state (stand-by, discharge, charging) of the battery modules for the control of valves 6 and three-way valves 8.

The described positive effect can be further amplified during discharge in partial load operating modes C and D if the battery strings or battery string groups in question are not shifted into standby but are switched to charging. This means that, while the majority of the battery modules are discharged, the remaining battery modules are charged. The power output of the battery power plant is then determined by the power difference between the two battery module groups. Since the charging of a Redox Flow battery is endothermic, the cooling effect of the battery modules switched to charging is correspondingly greater compared to stand-by mode. Whether this results in an increase in efficiency compared to the operating modes that use stand-by depends on many factors and must therefore be considered on a case-by-case basis. Sometimes it will be cheaper to temporarily activate cooling device 9 if the cooling capacity of the battery modules were to be no longer sufficient in stand-by.

For a battery power plant to be set up to carry out the procedures described above in an automated manner, it includes a computer system. The term computer system refers to all equipment that is suitable for carrying out the described process steps automatically, in particular ICs or microcontrollers specially developed for this purpose, as well as ASICs (ASIC: application specific integrated circuit). Control device 11 or controls 14, 16 may themselves include a suitable computer system. Alternatively, the computer system may represent separate equipment or be part of separate equipment. The present application is also based on a computer program including commands which cause the battery power plant to implement the procedures described above. In addition, the present application is based on a computer-readable medium on which such a computer program is stored.

In conclusion it should be mentioned that large battery power plants can also include several buildings, wherein several battery strings connected in parallel are arranged in each building. A separate cooling system can thereby be provided for each building, or an entire cooling system can be provided for all buildings collectively. In the first case, each building would be considered as a battery power plant according to the present invention. In the second case, the entirety of the buildings would be considered as a battery power plant according to the present invention.

### COMPONENT IDENTIFICATION LISTING

1 Battery module
2 Cell arrangement
3 Tank equipment
4 Temperature sensor
5 Heat exchangers
6 Valve
7 Battery string
8 Three-way valve
9 Cooling device
10 Circulating pump
11 Control device of the cooling system
12 Temperature sensor
13 DC-DC actuators
14 Control of a battery string
15 DC-AC converters
16 Control of a battery string group
17 Central control of the battery power plant

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A battery power plant, comprising:
a plurality of battery modules of the Redox Flow type, each of the plurality of battery modules including a tank device configured for storing an electrolyte, at least one first temperature sensor, and at least one heat exchanger, the at least one first temperature sensor being configured for detecting an electrolyte temperature, the at least one heat exchanger being configured for exchanging heat with the electrolyte;
a plurality of battery strings connected in parallel relative to one another, the plurality of battery strings including the plurality of battery modules such that each of the plurality of battery strings includes respective ones of the plurality of battery modules which are connected in series relative to one another; and
a cooling system configured for supplying a cooling fluid to heat the at least one heat exchanger of the plurality of battery modules, the cooling system including a cooling circuit including a flow, a return, at least one cooling device, and at least one circulating pump configured for circulating the cooling fluid in the cooling circuit, the cooling device being configured for influencing a temperature difference between the flow and the return, the cooling system including at least two second temperature sensors configured for detecting a temperature of the flow and the return, each of the plurality of battery modules being connected to the flow and the return of the cooling circuit in such a way that the cooling circuit forms a parallel connection of all the plurality of battery modules, the cooling system including at least one three-way valve which is configured for controlling a volume flow of the cooling fluid flowing through the cooling device, the cooling system for each of the plurality of battery modules including at least one first valve which is configured for controlling a volume flow of the cooling fluid flowing through the at least one heat exchanger of an associated one of the plurality of battery modules, and the cooling system including a control device which is configured for processing a plurality of values measured by the at least one first temperature sensor and the at least two second temperature sensors and for controlling a plurality of settings of the at least one first valve and the at least one three-way valve in order to improve the efficiency of the battery power plant.

2. The battery power plant according to claim 1, wherein respective ones of the plurality of battery modules form a cooling string, wherein the cooling string includes two parallel lines, and each one of the plurality of battery modules belonging to the cooling string is connected to the two parallel lines in such a way as to form a parallel connection, wherein the cooling system further includes another three-way valve which is provided for the cooling string, the other three-way valve being arranged in such a way that it can control a volume flow of the cooling fluid which flows through the respective cooling string, and wherein the control device is configured for controlling a setting of the other three-way valve belonging to the cooling string.

3. The battery power plant according to claim 1, wherein the battery power plant is arranged to carry out a method automatically, wherein the method including the step of controlling, in at least one operating state, the at least one first valve and the at least one three-way valve in such a way that at least one of the plurality of battery modules absorbs heat through the cooling fluid circulating in the cooling circuit which has been transferred to the cooling fluid by another one of the plurality of battery modules.

4. A method for operating a battery power plant, the method comprising the steps of:
providing that the battery power plant includes:
a plurality of battery modules of the Redox Flow type, each of the plurality of battery modules including a tank device configured for storing an electrolyte, at least one first temperature sensor, and at least one heat exchanger, the at least one first temperature sensor being configured for detecting an electrolyte temperature, the at least one heat exchanger being configured for exchanging heat with the electrolyte;
a plurality of battery strings connected in parallel relative to one another, the plurality of battery strings including the plurality of battery modules such that each of the plurality of battery strings includes respective ones of the plurality of battery modules which are connected in series relative to one another; and
a cooling system configured for supplying a cooling fluid to heat the at least one heat exchanger of the plurality of battery modules, the cooling system including a cooling circuit including a flow, a return, at least one cooling device, and at least one circulating pump configured for circulating the cooling fluid in the cooling circuit, the cooling device being configured for influencing a temperature difference between the flow and the return, the cooling system including at least two second temperature sensors configured for detecting a temperature of the flow and the return, each of the plurality of battery modules being connected to the flow and the return of the cooling circuit in such a way that the cooling circuit forms a parallel connection of all the plurality of battery modules, the cooling system including at least one three-way valve which is configured for controlling a volume flow of the cooling fluid flowing through the cooling device, the cooling system for each of the plurality of battery modules including at least one first valve which is configured for controlling a volume flow of the cooling fluid flowing through the at least one heat exchanger of an associated one of the plurality of battery modules, and the cooling system including a control device which is configured for processing a plurality of values measured by the at least one first temperature sensor and the at least two second temperature sensors and for controlling a plurality of settings of the at least one first valve and the at least one three-way valve; and
controlling, in at least one operating state, the at least one first valve and the at least one three-way valve in such a way that at least one of the plurality of battery modules absorbs heat through the cooling fluid circulating in the cooling circuit which has been transferred to the cooling fluid by another one of the plurality of battery modules.

5. The method according to claim 4, wherein respective ones of the plurality of battery modules form a cooling string, wherein the cooling string includes two parallel lines, and each one of the plurality of battery modules belonging to the cooling string is connected to the two parallel lines in such a way as to form a parallel connection, wherein the cooling system further includes another three-way valve which is provided for the cooling string, the other three-way valve being arranged in such a way that it can control a volume flow of the cooling fluid flowing through the respective cooling string, and wherein the control device is configured for controlling a setting of the other three-way valve associated with the cooling string.

6. The method according to claim 4, wherein the battery power plant is operated in at least one operating state at a partial load, and wherein at least one of the plurality of battery modules, which absorbs heat through the cooling fluid circulating in the cooling circuit, is in a stand-by mode.

7. The method according to claim 4, wherein the battery power plant is operated in at least one operating state at a partial load, and wherein at least one of the plurality of battery modules, which absorbs heat through the cooling fluid circulating in the cooling circuit, is charged.

8. The method according to claim 4, further comprising the step of providing a controller which is configured for causing the battery power plant to carry out the method.

9. The method according to claim 8, wherein the controller includes a computer-readable medium which includes instructions which at least in part are configured for causing the battery power plant to carry out the method.
